(19) United States
(12) Patent Application Publication
(10) Pub. No.: US 2009/0154014 A1
(43) Pub. Date: Jun. 18, 2009

(54) Thin film magnetic head and manufacturing method thereof

(76) Inventors: Kazue Kudo, Kanagawa (JP); Hiromi Shiina, Ibaraki (JP); Yoji Maruyama, Saitama (JP); Gen Oikawa, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(21) Appl. No.: 12/313,965

(22) Filed: Nov. 25, 2008

(30) Foreign Application Priority Data
Dec. 18, 2007 (JP) 2007-326112

(51) Int. Cl. G11B 5/127; C25D 3/56

(52) U.S. Cl. 360/125.03; 205/255; G9B/5.04

(57) ABSTRACT

Embodiments of the present invention improve the recording density of a magnetic disk drives by providing a write head capable of writing adequately on a narrow trackwidth and high coercivity recording media. According to one embodiment, a thin film magnetic head has a write head which comprises at least a main magnetic pole, a yoke and a return pole, wherein a magnetic film which constitutes at least a part of the main magnetic pole, the yoke or the return pole is formed by alternately plating first magnetic layers and second magnetic layers, each of the first magnetic layer being of the body-centered cubic phase and containing at least two of elements Co, Ni and Fe, and each of the second magnetic layer being of the face-centered cubic phase and containing at least two of elements Co, Ni and Fe. The thin-film magnetic head can attain high Bs even if the magnetic film is thinned. In addition, high μ can be attained even when the recording frequency is high.

### CROSS-REFERENCE TO RELATED APPLICATION

The instant nonprovisional patent application claims priority to Japanese Patent Application No. 2007-326112 filed Dec. 18, 2007 and which is incorporated by reference in its entirety herein for all purposes.

### BACKGROUND OF THE INVENTION

Various types of disk drive devices are known, which include optical disk drives, optical magnetic drives, and flexible magnetic disk drives. Among them, the hard disk drive (HDD) has become popular as a storage device for computers. The HDD has become one of the storage devices indispensable for today's computer systems. The HDD is a magnetic disk drive.

A magnetic disk drive uses a thin film magnetic head to write magnetic information on recording media and read magnetic information from recording media. In order to increase the amount of magnetic information or data which can be recorded to recording media, magnetic disk drives are increasing in recording density. This is accompanied with a demand for recording media having higher coercivity. Thus, in order to write on higher coercivity recording media without error, the magnetic core material for write heads must have a high saturation flux density to provide a strong magnetic field for writing on recording media.

Materials with high saturation flux densities (Bs) are disclosed in Japanese Patent Publication No. 11-074122 (“Patent Document 1”) and Japanese Patent Publication No. 2000-173014 (“Patent Document 2”). Disclosed in Patent Document 1 is a cobalt-iron-nickel magnetic film to form the upper magnetic layer and the lower magnetic layer or the upper shield layer. This magnetic film is 40-70% cobalt by weight, 20-40% iron by weight and 10-20% nickel by weight and has a mixed crystal structure made by mixing body-centered cubic (y phase) with face-centered cubic (a phase). This mixed crystal is realized by growing both body-centered cubic and face-centered cubic structure in the same plane. Disclosed in Patent Document 2 is a magnetic write head where the upper and lower magnetic cores use a magnetic thin film which contains 25-40 at % Fe, 10-15 at % Ni, 40-70 at % Co and 0-0.3 at % S and has a face-centered cubic crystal structure or a quasi face-centered cubic crystal structure including a small number of body-centered cubes.

For further progress of magnetic disk drives in recording densities, write heads must be capable of writing adequately on narrower trackwidth, higher coercivity recording media. Specifically, narrowing the trackwidth of a recording medium makes it necessary to narrow the trackwidth of the write head's main pole and thin the magnetic film, resulting in deteriorated magnetization characteristic. Further, if the coercivity of the recording medium is raised, the write head must generate stronger recording magnetic field in order to write on the magnetic medium without error. Thus, the material used to form the write head's magnetic film must be such that the magnetic film, although thinned, has a large saturation flux density (hereinafter, denoted as “BS”).

In view of affinity with high speed communication, it is necessary to raise the recording frequency. For this purpose, hysteresis loss in the main magnetic pole, auxiliary magnetic pole and other sections of the write head must be reduced by raising the recording magnetic field conversion efficiency of the coil current. The material of choice must have a low coercivity (hereinafter, denoted as “Hc”) in the hard axis direction or a low anisotropy magnetic field (hereinafter, denoted as “Hk”) and a high permeability (hereinafter, denoted as “μ”).

Although CoNiFe alloys are conventionally deposited as high Bs films by electroplating, sufficiently high Bs has not yet been achieved. In addition, although these alloys have high Bs as materials, practical application is not yet possible since thinning of the films is difficult.

The magnetic film used in the thin-film magnetic head disclosed in Patent Document 1 has a Bs of 1.9 T-2.2 T. This is not enough high to realize higher recording densities. The magnetic thin film in the magnetic write head disclosed in Patent Document 2 is also not possible to enable higher recording densities since it shows a low Bs of 2.0 T and high Hk of 16 Oe. In addition, no mention is given to p in either Patent Document 1 or 2.

### BRIEF SUMMARY OF THE INVENTION

Embodiments of the present invention improve the recording density of magnetic disk drives by providing a write head capable of writing adequately on a narrow trackwidth and high coercivity recording media. One embodiment of the present invention provides a thin film magnetic head having a write head which comprises at least a main magnetic pole, a yoke and a return pole, wherein a magnetic film which constitutes at least a part of the main magnetic pole, the yoke or the return pole is formed by alternately plating first magnetic layers and second magnetic layers, each of the first magnetic layer being of the body-centered cubic phase and containing at least two of elements Co, Ni and Fe, and each of the second magnetic layer being of the face-centered cubic phase and containing at least two of elements Co, Ni and Fe. The thin-film magnetic head can attain high Bs even if the magnetic film is thinned. In addition, high μ can be attained even when the recording frequency is high.

### BRIEF DESCRIPTION OF THE DRAWINGS

FIG. 1 is a schematic view showing an example of a magnetic disk drive to which an embodiment is applied.

FIG. 2 is a schematic view showing an example of a thin film magnetic head of one embodiment.

FIG. 3 is a view showing how the Bs of a FeCoNi plated film depends on the Fe, Co and Ni concentrations in the film.

FIG. 4 is a graph showing relation between the membrane stress in a magnetic film and the sulfur content of the film according to an embodiment.

FIG. 5 is a view showing the conditions concerning the electroplating bath for an embodiment.

FIG. 6 is a view showing a cross sectional FIB photo of a magnetic film of an embodiment.

FIG. 7 is a view showing B-H curves of a plated magnetic thin film of an embodiment and those of a magnetic film fabricated as an example for comparison.

FIG. 8 is a view showing the permeability p of the plated magnetic thin film of an embodiment and that of the comparative example.

FIG. 9 is a view showing a result of X-ray diffraction of the plated magnetic thin film of an embodiment.

FIG. 10 is a view showing the lattice constants of the magnetic plated thin film of an embodiment.

### DETAILED DESCRIPTION OF THE INVENTION

Embodiments of the present invention relate to thin film magnetic heads and manufacturing methods thereof and, in particular, a thin film magnetic head using a high saturation flux density and high permeability thin magnetic film and a manufacturing method thereof.

Made in view of the above-mentioned conventional problem, embodiments of the present invention provide a thin-film magnetic head using a magnetic film with higher Bs and higher μ than conventional and a manufacturing method thereof. In addition, embodiments of the present invention provide a magnetic disk drive having this thin-film magnetic head mounted therein.

Specifically, there is provided a thin film magnetic head comprising a write head including at least a main magnetic pole, a yoke and a return pole. In the thin film magnetic head, a magnetic film which comprises at least a part of the main magnetic pole, the yoke or the return pole is formed by alternately plating first magnetic layers and second magnetic layers. Each of the first magnetic layer is of the body-centered cubic phase and contains at least two of elements Co, Ni and Fe. Each of the second magnetic layer is of the face-centered cubic phase and contains at least two of the elements Co, Ni and Fe.

In addition, there is provided a method for manufacturing a thin film magnetic head comprising a write head including at least a main magnetic pole, a yoke and a return pole. In this method, a magnetic film which constitutes at least a part of the main magnetic pole, the yoke or the return pole is formed by alternately repeating: a first step of applying a current at a density of 150 mA/cm² or more into a plating bath which contains not only at least two kinds of Co, Ni and Fe ions but also a complex of S and has the pH kept at 2.0 or lower; and a second step of applying a current at a density below 150 mA/cm².

The thin-film magnetic head of embodiments of the present invention can attain high Bs even if the magnetic film is thinned. In addition, high μ can be attained even when the recording frequency is high. Further, the manufacturing method of embodiments of the present invention make it possible to manufacture a thin-film magnetic head having these effects implemented.

The following will describes embodiments of the present invention with reference to the drawings. For the purpose of making the description clear, omission and simplification are done in the description and drawings as appropriate. For the same purpose, identical elements in the drawings are given the same reference numeral and redundant description thereof is omitted when unnecessary.

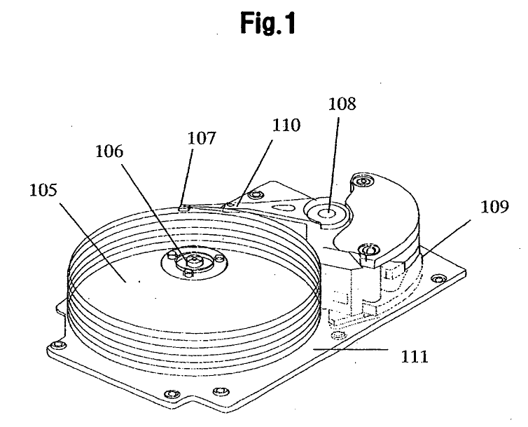

First, the following provides a general description of a magnetic disk drive for one embodiment with reference to FIG. 1. The magnetic disk drive comprises a magnetic recording medium 105 to record information thereon, a spindle motor 106 to rotate the magnetic recording medium, a thin-film magnetic head 107 to write and read information to and from the magnetic recording medium and an actuator 108 and voice coil motor 109 to locate the thin-film magnetic head to a target position on the magnetic recording medium. At the front end of the actuator, a suspension 110 is fixed so that the thin-film magnetic head flies stably above the magnetic recording medium with a submicron space between them during the time of writing or reading. A guide arm 111 is also provided which is driven by the actuator and voice coil motor. In addition, the magnetic disk drive is provided with a magnetic recording medium rotation control system, a head positioning control system and a read/write signal processing system (not shown in the figure).

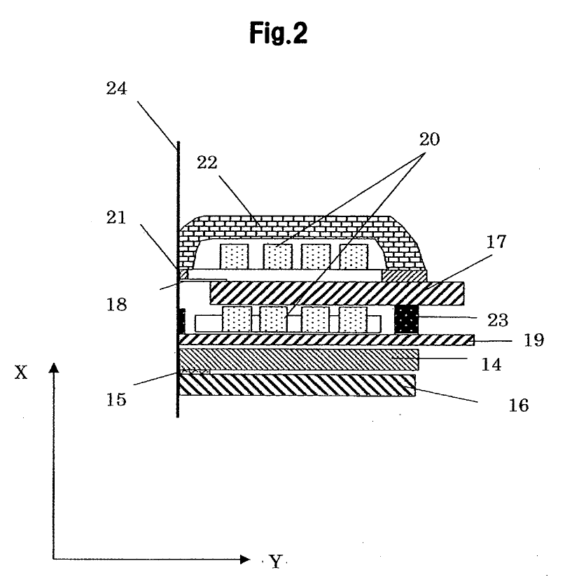

Then, the following provides a detailed description of a thin-film magnetic head 107 which writes and reads information to and from the magnetic recording medium 105 according to the present embodiment. FIG. 2 shows a perpendicular recording thin-film magnetic head. Hereinafter, the X direction in FIG. 2 is called the trailing direction. Likewise, the direction opposite to the trailing direction is called the leading direction while the Y direction is called the head backward direction. As well, the surface indicated by line 24 is called the air bearing surface of the head. The thin-film magnetic head is manufactured by forming the individual parts on a non-magnetic substrate (not shown in the figure) one by one in the trailing direction. Accordingly, the trailing direction and leading direction are also called the upward direction and downward direction, respectively. Note that there are various types of perpendicular recording thin-film magnetic heads and the present embodiment uses one example thereof. In addition, although the present embodiment is a perpendicular recording thin-film magnetic head, it is needless to say that the head may be an in-plane recording thin-film magnetic head.

First, a read head is formed on the non-magnetic substrate (not shown in the figure). Specifically, after a lower shield film 16 and a lower magnetic gap film (not shown in the figure) are formed, a MR, GMR or TMR sensor or the like is formed thereon as a read element 15. Then, after a magnetic domain control layer, an electrode film and an upper magnetic gap film (not shown in the figure) are formed, an upper magnetic shield film 14 is formed.

Next, a write head is formed on the read head. A magnetic gap film is deposited on the read head before the write head is formed thereon. After an auxiliary magnetic pole 19 is formed thereon, an alumina film is deposited by sputtering. Then, after the auxiliary magnetic pole is planarized by CMP, an underlayer film for a lower magnetic pole 23 is deposited by sputtering. On the underlayer film, a CoNiFe film or 46 NiFe film is deposited to a certain thickness by plating. Alternatively, the perpendicular recording thin-film magnetic head may be configured so that such a lower magnetic pole is not formed and only the terminal sections are plated. In this case, after an insulation film is deposited, the insulation film is removed only from the terminal sections. Then, after an insulation film, a coil 20 to which the recording current is applied, and an organic insulation layer are formed, an alumina film is deposited by sputtering and the lower magnetic pole 23 is planarized by CMP. Note that embodiments of the present invention are also applicable to a perpendicular recording thin film magnetic head where the auxiliary magnetic pole and the lower magnetic pole are not provided. Next is the formation of a yoke 17.

After an underlayer film for the yoke 17 is deposited, a film with high Bs and high μ is deposited on the underlayer film through an objective pattern formed thereon. Then, after the underlayer film is removed, an alumina film is deposited by sputtering and the yoke 17 is planarized by CMP. Next is the formation of a main magnetic pole 18. After an underlayer film is deposited by sputtering, a plated film of an embodiment of the present invention is 0.7 μm deposited on the underlayer film through an objective resist pattern formed thereon. The plated film of an embodiment of the present invention will be described later in detail. After the resist is removed and trimming is done, an alumina film and a stopper film are sequentially deposited and planarized to a desired thickness by CMP. Alternatively, the plated film of the present embodiment may be deposited at first in forming the main magnetic pole 18. In this case, the plated film is trimmed through an objective pattern formed thereon. That is, the main magnetic pole 18 may also be formed by partly using a magnetic film which is deposited according to the present embodiment. After a gap film is deposited, a shield 21 is formed. Then, after an alumina film is deposited by sputtering, the shield 21 is planarized by CMP. After the recording current application coil 20 and the organic insulation layer are formed, a return pole 22 is formed by plating. The head is completed by carrying out the terminal-related process.

Although a plated film of an embodiment is wholly or partly used to form the main magnetic pole, its use is not limited thereto. It may also be used to form components which are required to have high Bs and/or high μ. For example, such components include the auxiliary magnetic pole 19, yoke 17, return pole 22 and lower magnetic pole 23.

The magnetic film of an embodiment is described below in detail. The magnetic film of the present embodiment is formed by alternately depositing first magnetic layers of the body-centered cubic phase and second magnetic layers of the face-centered cubic phase. In total, the magnetic film is 10 wt %-55 wt % Co, 0 wt %-15 wt % Ni and 30 wt %-75 wt % Fe. The first magnetic layers of the body-centered cubic phase are different in composition from the second magnetic layers of the face-centered cubic phase. Since these layers are alternately formed, it is possible to stop the growth of each magnetic layer at its boundary with the adjacent first or second magnetic layer, resulting in finer crystal grains. Since finer crystal grains respond faster to magnetic changes, it is possible to realize higher μ.

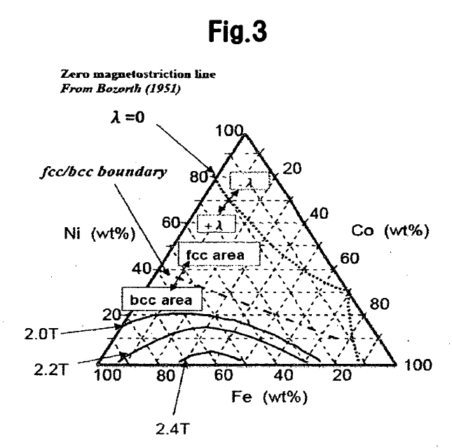

FIG. 3 shows a Co, Ni and Fe ternary composition diagram. As shown in the figure, the boundary between the face-centered cubic phase and the body-centered cubic phase approximately lies on a straight line between the point 20 wt % Fe, 70 wt % Co, 10 wt % Ni and the point 40 wt % Ni, 60 wt % Fe.

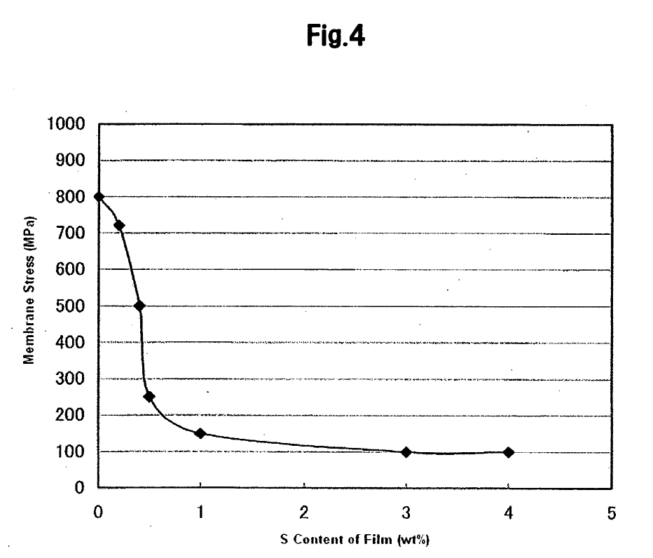

The first magnetic layer comprises at least two of three elements Co, Ni and Fe and includes S. Specifically, it contains 10 wt %-40 wt % Co, 0 wt %-5 wt % Ni, 55 wt %-90 wt % Fe and 0.5 wt %-1.0 wt % S. Thus, the first magnetic layers of the magnetic film of the present embodiment contains S in a range of 0.5 wt %-1.0 wt %. Inclusion of S makes crystal grains finer, making it possible to realize high Bs. Another reason that the S content is set to 0.5 wt %-1.0 wt % is described below. If the S content exceeds 1.0 wt %, the film deteriorates in anti-corrosion resistance. In addition, as shown in FIG. 4, if the S content is reduced below 0.5 wt %, the membrane stress suddenly increases, resulting in a thin film which is likely to peel off. Accordingly, the S content is set to 0.5 wt %-1.0 wt %. In addition, a/b of crystal grains in the first magnetic layer is 0.995 or smaller, where a is the crystalline lattice constant of the surface parallel to the film surface and b is the crystalline lattice constant of the surface perpendicular to the film surface.

The second magnetic layer uses plated layer having a negative magnetostriction constant. In FIG. 3, the magnetostriction constant is negative if the composition is on the Co side of the broken line. Specifically, a negative magnetostriction constant is attained if the composition lies within the region surrounded by the (Ni: 80 wt %-100 wt %) line, the (Co: 0 wt %-70 wt %) line and the line which starts at the (Co: 70 wt %) point and goes through the (Fe: 10 wt %, Co: 50 wt %, Ni: 40 wt %) point and the (Ni: 70 wt %, Co: 10 wt %, Fe: 20 wt %) point and ends at the (Ni: 80 wt %) point. The magnitude of the magnetostriction constant in the negative magnetostriction constant region is negligibly small as compared with the magnetostriction constant in the positive magnetostriction constant region. It is therefore possible to easily adjust the magnetostriction constant of the whole magnetic film as desired by adjusting the magnetostriction constant of the first magnetic layer. The desired magnetostriction constant is 100E-7 or smaller. By making the magnetostriction constant not higher than 100E-7, it is possible to prevent the easy magnetization direction of the magnetic film from changing due to post-plating processing.

Each second magnetic layer has a thickness of 0.5 nm or more. If the layer is thinner than 0.5 nm, since the growth of each magnetic layer can not be stopped by the boundary between the first and second magnetic layers, it is not possible to make crystal grains finer. Giving thought to a margin, a thickness of 2 nm or more may be provided.

The ratio of the first magnetic layers to the whole magnetic film is larger than the ratio of the second magnetic layers to the whole magnetic film. This is because since the first magnetic layers can realize higher Bs than the second magnetic layers, the Bs of the whole magnetic film is kept higher if the ratio of the first magnetic layers is larger than the ratio of the second magnetic layers. In the present embodiment, the ratio of the first magnetic layers to the whole film is set to 80% or higher so that they have dominant influence on the Bs of the whole film. This makes it possible for the magnetic film to have a Bs of 2.2 T or higher.

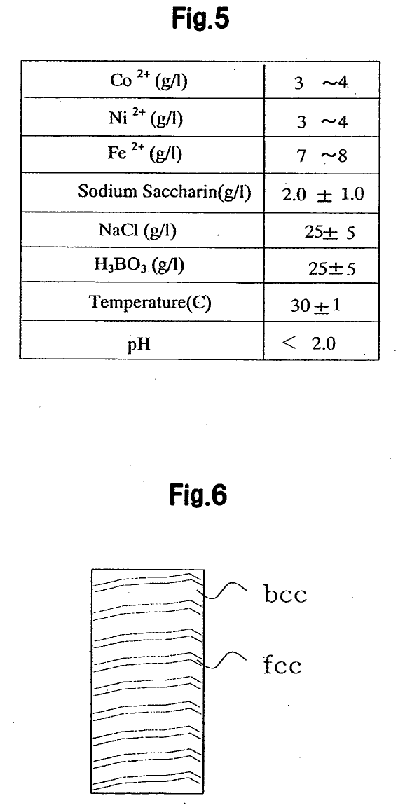

The following describes in detail a method for manufacturing the thin-film magnetic head according to one embodiment. The main magnetic pole in the thin-film magnetic head of the present embodiment is formed by electroplating in a plating bath prescribed in FIG. 5. As shown in FIG. 5, the plating bath contains S in the form of a complex as well as Co ions, Ni ions and Fe ions. To introduce S, the plating bath contains saccharin sodium. To plate the first magnetic layer of the body-centered cubic structure, the current density is set to 150 mA/cm2 or higher. To plate the second magnetic layer of the face-centered cubic structure, the current density is set to below 150 mA/cm². To make the magnetostriction constant negative, the density may be set to 3 mA/cm² or lower. That is, if the composition of the plating solution is set as prescribed in FIG. 5, the magnetic film of the present embodiment can be formed in the same plating bath since first magnetic layers of the body-centered cubic structure and second magnetic layers of the face-centered cubic structure can alternately be plated only by changing the current density.

To plate the first magnetic layers, the current density is set to 150 mA/cm² or higher since S would not sufficiently be introduced into the magnetic film if the current density is lower than 150 mA/cm². If the current density is below 150 mA/cm², it is not possible to raise the S content of the magnetic film to the range of 0.5 wt %-1.0 wt %. Even if the current density is 100 mA/cm² or higher, it is not possible to realize remarkably high Bs and μ while the S content is not as high as desired.

To electroplate first magnetic layers, a constant DC current or a pulse current is applied. In the case of a constant DC current, the film is likely to be plated abnormally if the current density is high. Specifically, if the current density is raised, the plating reaction is sped up, resulting in exhausted ions supplied to the interface faster and therefore abnormal plating is conducted. Using a pulse current provides non-current time (off time). This enables recovery of the concentration, resulting in normal plating.

If the current density in the plating bath is as high as 150 mA/cm², the plating rate may be so high as to cause abnormal plating and have influence on the surface roughness. By setting the pH not higher than 2.0, the plating rate can be lowered to suppress abnormal growth. If the pH is not higher than 2.0, the plated film is not likely to be clouded. To control the pH at 2.0 or lower, sulfuric acid or hydrochloric acid is added depending on the measured pH in order to suppress the rise of the pH. If the pH is lowered below 0.8, hydrogen ions increase excessively in the bath. This results in a small voltage and therefore abnormal plating is conducted even if a high density current is applied.

Since the plating rate is high, N₂ bubbling or paddling may be performed. This is effective to plating a uniformly distributed film.

FIG. 6 schematically depicts an observed cross section of a magnetic film which is plated inside a pattern according to the present embodiment and processed by a Focused Ion Beam. This indicates that even inside the pattern, a multi-layered film comprising body-centered cubic phase layers and face-centered cubic phase layers can be formed.

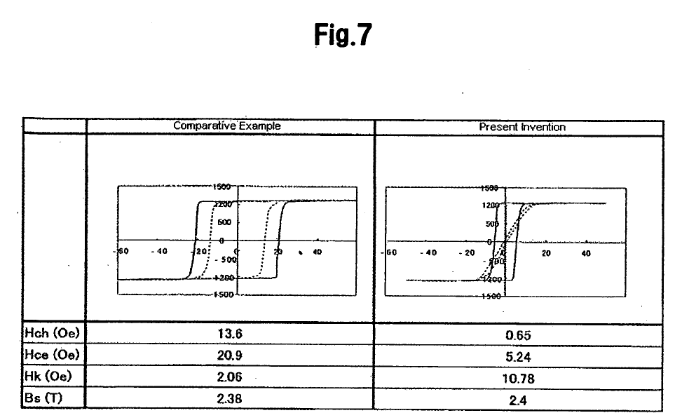

FIG. 7 shows B-H curves of a multi-layered plated magnetic film which was formed according to one embodiment by alternately plating first magnetic layers and second magnetic layer in a plating bath prepared as prescribed in FIG. 5. Each first layer was plated for 30 seconds at a current density of 200 mA/cm² whereas each second layer was plated for 1 minute and 30 seconds at a current density of 2 mA/cm². B-H carves of a comparative example are also shown. Not like the magnetic film of the present embodiment which has both body-centered and face-centered cubic phases stacked alternatively, the comparative example is a single-layered film of the body-centered phase which was continuously plated in the plating bath prepared as prescribed in FIG. 5 at an unchanged current density of 6 mA/cm². The magnetic film fabricated according to the manufacturing method of the present embodiment shows lower coercivities (hard axis: Hch, easy axis: Hce) and higher Bs (as high as 2.4 T) than the comparative example. That is, soft magnetic properties were improved by setting the S content to the range of 0.5 wt %-1.0 wt %, making crystal grains finer and compressing crystal grains. Although the anisotropy magnetic field Hk shows a small increase, the soft magnetic properties are improved due to the greatly improved coercivities.

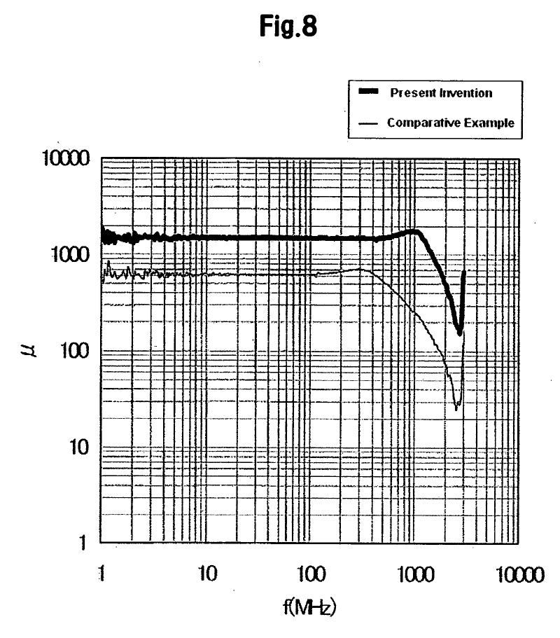

FIG. 8 shows μ curves of the magnetic film fabricated by the comparative manufacturing method and the magnetic film fabricated by the manufacturing method of one embodiment, respectively. The magnetic film fabricated by the comparative manufacturing method shows a maximum permeability of 700 and a high frequency permeability of 150 at 1 GH, which are not sufficiently high. The magnetic film fabricated by the manufacturing method of the present embodiment shows a maximum permeability of 1600 and a high frequency permeability μ of 1700 even at 1 GHz. Thus, the magnetic film fabricated by the manufacturing method of the present embodiment attains a higher maximum permeability and shows improved high frequency characteristics with almost no fall in the high frequency region. The maximum permeability μ can not be raised above 1000 unless the first magnetic layer contains at least two of three elements Co, Ni and Fe and includes S as in the present embodiment or, more specifically, unless it contains 10 wt %-40 wt % Co, 0 wt %-5 wt % Ni, 55 wt %-90 wt % Fe and 0.5 wt %-1.0 wt % S. Thus, the first magnetic layers of the magnetic film of the present embodiment contains S in a range of 0.5 wt %-1.0 wt %.

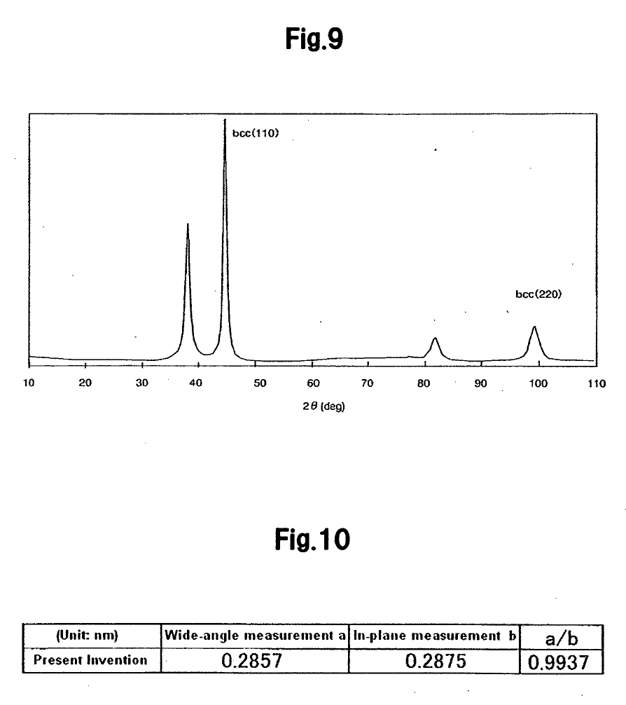

FIG. 9 shows the X-ray diffraction pattern of this plated magnetic thin film containing the body-centered cubic (bcc) structure. This diffraction pattern is dominantly attributable to the bcc structure.

FIG. 10 shows lattice constants determined from the above diffraction pattern. In the case of a regular cubic system, a=b or a/b=1, where a is the crystalline lattice constant of the surface parallel to the film surface, that is, film thickness direction, and b is the crystalline lattice constant of the surface perpendicular to the film surface, that is, film in-plane direction. In the case of the plated film of the present embodiment, a/b=0.0994, that is, the plated film is compressed in its thickness direction. The higher Bs (Bs>2.4 T) seems attributable to this compression of crystals.

What is claimed is:

1. A thin film magnetic head comprising:
a write head including at least a main magnetic pole, a yoke, and a return pole,
wherein a magnetic film comprising at least a part of the main magnetic pole, the yoke, or the return pole, is formed by alternately plating first magnetic layers and second magnetic layers, each of the first magnetic layers being of the body-centered cubic phase and containing at least two of the elements Co, Ni and Fe, and each of the second magnetic layers being of the face-centered cubic phase and containing at least two of the elements Co, Ni and Fe.

2. The thin film magnetic head according to claim 1, wherein each of the first magnetic layers comprises 10 wt %-40 wt % Co, 0 wt %-5 wt % Ni, 55 wt %-90 wt % Fe and 0.5 wt %-1.0 wt % S.

3. The thin film magnetic head according to claim 2, wherein the magnetic film comprises 10 wt %-55 wt % Co, 0 wt %-15 wt % Ni and 30 wt %-75 wt % Fe.

4. The thin film magnetic head according to claim 3, wherein a ratio of the first magnetic layers to the whole magnetic film is larger than a ratio of the second magnetic layers to the whole magnetic film.

5. The thin film magnetic head according to claim 4, wherein a ratio of the first magnetic layers to the whole magnetic film is 80% or more.

6. The thin film magnetic head according to claim 1, wherein each of the second magnetic layers has a negative magnetostriction constant.

7. The thin film magnetic head according to claim 1, wherein each of the second magnetic layers has a thickness of 0.5 nm or more.

8. A magnetic recording device comprising:
a thin film magnetic head comprising,
a write head including at least a main magnetic pole, a yoke, and a return pole, wherein a magnetic film comprising at least a part of the main magnetic pole, the yoke, or the return pole, is formed by alternately plating first magnetic layers and second magnetic layers, each of the first magnetic layers being of the body-centered cubic phase and containing at least two of the elements Co, Ni and Fe, and each of the second magnetic layers being of the face-centered cubic phase and containing at least two of the elements Co, Ni and Fe; and
a magnetic recording medium which is accessed by the thin film magnetic head.

9. A method for manufacturing a thin film magnetic head comprising a write head including a main magnetic pole, a yoke, and a return pole, the method comprising:
forming a magnetic film which comprises at least a part of the main magnetic pole, the yoke, or the return pole by alternately repeating,
first applying a current at a density of 150 mA/cm2 or more into a plating bath containing ions of at least two of Co, Ni, and Fe, and a complex of S, and has a pH kept at 2.0 or lower; and then
applying a current at a density below 150 mA/cm².

10. The method for manufacturing a thin film magnetic head according to claim 9, wherein the current in the second step is applied at a density of 3 mA/cm² or lower.

11. The method for manufacturing a thin film magnetic head according to claim 9, wherein the current applied in the first step is a pulse current.

12. The method for manufacturing a thin film magnetic head according to claim 9, wherein nitrogen bubbling and paddling are performed when the magnetic film is formed.

13. A method for manufacturing a thin film magnetic head comprising a write head including at least a main magnetic pole, a yoke, and a return pole, wherein a magnetic film which comprises at least a part of the main magnetic pole, the yoke, or the return pole is formed by alternately repeating:
first applying a current into a plating bath which contains ions of at least two of Co, Ni, and Fe, and also a complex of S, and has a pH kept at 2.0 or lower, the applied current density being set so as to grow the body-centered cubic phase; and
a second step of applying a current at such a density as to grow the face-centered cubic phase.

14. The method for manufacturing a thin film magnetic head according to claim 13, wherein the current applied in the second step is set so as to make negative the magnetostriction constant of the plated layer.

15. The method for manufacturing a thin film magnetic head according to claim 13, wherein the current applied in the first step is a pulse current.

16. The method for manufacturing a thin film magnetic head according to claim 13, wherein nitrogen bubbling and paddling are performed when the magnetic film is formed.
